(19) United States
(12) Patent Application Publication
(10) Pub. No.: US 2014/0272410 A1
(43) Pub. Date: Sep. 18, 2014

(54) ENERGY STORING FRACTAL AND PROCESS THEREFOR

(71) Applicants: Robert J. Miller, Belmont, CA (US); Alevtina White Smirnova, Rapid City, SD (US)

(72) Inventors: Robert J. Miller, Belmont, CA (US); Alevtina White Smirnova, Rapid City, SD (US)

(21) Appl. No.: 13/831,033

(22) Filed: Mar. 14, 2013

(51) Int. Cl. H01G 11/36

(52) U.S. Cl. CPC H01G 11/36; B82Y 99/00
USPC 428/368; 428/408; 428/367; 977/752

(57) ABSTRACT

A fractal microstructure which includes multi-walled carbon nanotubes suited for customizable volumetric energy and power densities. Electrode monoliths can be formed from a variety of process steps including some or all of RF polymerization, RF coalescence and ripening at intersections, and multi-walled carbon nanotube crosslinking. The resulting nanocomposite is capable of performing all five functions of an electrode while at the same time offering robust mechanical strength and significantly improved energy storage capabilities through, among other things, intra- and inter-particle interlocking.

### RELATED APPLICATIONS

This application is a continuation-in-part of Ser. No. 12/844,787, filed Jul. 27, 2010, which in turn is a conversion of the following provisional applications: Ser. No. 61/364,667, filed Jul. 15, 2010; Ser. No. 61/363,104, filed Jul. 9, 2010; and Ser. No. 61/228,831, filed Jul. 27, 2009. This application is also a continuation-in-part of Ser. No. 13/417,199, filed Mar. 9, 2012, which in turn is a continuation of Ser. No. 13/135,608, filed Jul. 11, 2011, which in turn is a conversion of Ser. No. 61/363,104, filed Jul. 9, 2010, and Ser. No. 61/364,667, filed Jul. 15, 2010. The present application claims the benefit of the foregoing applications, each of which is incorporated by reference.

### FIELD OF THE INVENTION

The present invention relates to energy storing microstructures and techniques, and, more particularly, relates to particles comprised of hierarchical nanocomposites for use in energy storing devices.

### BACKGROUND OF THE INVENTION

Power storage has long been a challenge. With the advent of portable electronic devices, the search for materials and structures offering ever-increasing power density, structural integrity, and ease of manufacture and use has accelerated. As such portable devices have become ubiquitous, with ever-greater energy requirements, the need for improved energy storage elements has brought into focus the shortcomings of prior approaches.

Historically, the typical energy storage device has been a battery, or sometimes a capacitor. More recently supercapacitors have been proposed, but with little commercial application, especially for portable devices. Devices based on carbon particles have also been used, usually in the form of activated carbon black and carbon aerogels, where the particle sizes are in the range of microns, but, among other limitations, these devices have electrodes comprised of pore formers and binders that offer only limited durability. As such, numerous challenges exist to the ink design of a fully functional electrode that can be integrated into structural materials.

Similarly, while bimodal electrode materials are known in the art, such as the bimodal flow-through electrodes by Lawrence Livermore National Labs (LLNL) and the Nanofoam™ product line available from Marketek, Inc., neither has proved adequate. The LLNL bimodal carbon aerogels provide some of the functional requirements of EDLC electrodes, but fails to meet the durability requirements. Similarly, the Nanofoam™ material meets some of the requirements of a monolithic electrode but it is derived from carbon fibrous materials which occupy significant volume and thereby reduce the energy density available.

### SUMMARY OF THE INVENTION

The present invention provides a building block as a novel class of bimodal materials that radically simplifies the ink design for energy storage devices. The present invention permits the development of inks without binders and pore forming agents through the use of fusible designer particles that greatly increase intra- and inter-particle strength while improving mass transport and conductivity. The combination of features minimizes the need for supplying a stack pressure in a finished device that is then made thinner and more flexible than other similar devices, and permits the use of printable additive manufacturing processes for device assembly. Taken together, the resulting benefits include isolated, addressable energy cells, improved cycle life, better energy density for a given power density, and higher packaging efficiency. It is also anticipated that the new manufacturing techniques utilizing advanced materials engineered at multiple length scales will advance and accelerate technological advances in more useful energy storing devices. When fully realized, the multifunctional materials invented will also facilitate the development of multi-scale hierarchical energy dissipation at the nano- and micro-scale level enabled by creating microstructures that eliminate traditional inverse material property relationships.

The invention is an improvement over the hairy particle discussed in the co-pending and related application, Miller et. al. U.S. application Ser. No. 12/844,787. That application teaches a new type of building block for building tough interlocked electrode materials suitable for EDLC devices. In that application, hairy particles were formulated into inks suitable for printing and interlocking the hairy particles within an energy storing electrode. The present invention eliminates the need for additional porogens or binders to meet the requirements of the electrode, thereby enabling simplified ink development, higher strength and improved performance. On a nanoscale, one objective is to achieve a high surface area to volume ratio for the internal carbon aerogel (CA) phase or node, since, in general, the larger the surface area, the more charge storage per volume. However, the microstructure must also provide channels by which the charge can be discharged into for proper use in an EDLC device. Taken together, the smallest volume element that captures both objectives also defines the dimensions and is called a fractal microstructure.

The present invention provides a fractal microstructure suited for customizable volumetric energy and power densities within electrode materials, while also providing robust mechanical strength through, among other things, intra- and inter-particle interlocking. For purposes of the present invention, “fractal” refers to the optimal, smallest volume space that, when filled with appropriate materials, enables an electrode design in which all five functional requirements of an electrode exist. The five functions are: capacitance, thermal and electrical conductivity, mass transport, and mechanical strength for durability.

As a result, there has long been a need for a nanocomposite capable of performing all five functions of an electrode while at the same time offering robust mechanical strength and significantly improved energy storage capabilities.

These and other aspects and features of the invention can be better appreciated from the following Detailed Description of the Invention, taken together with the appended Figures, described below.

### THE FIGURES

FIG. 1 illustrates the fractal microstructure of the present invention.

FIGS. 2A-F show a plurality of hairy particles interlocked in accordance with the present invention, and further shows the mass transport channels of the present invention.

FIGS. 3A-C are images of particles before and after plasma treatment in accordance with the present invention.

FIG. 4 illustrates an embodiment of a process for creating bulk material in accordance with the present invention.

FIG. 5 illustrates an alternative embodiment to the process shown in FIG. 4.

FIG. 6 illustrates a porous shell with nanomaterial in accordance with an embodiment of the invention.

FIG. 7 is a SEM image showing fusible nanometals within MWNT shell material.

### DETAILED DESCRIPTION OF THE INVENTION

In an embodiment of the invention, FIG. 1 shows a sub-micron hairy particle 100 (center of figure) that is coordinated with six nearest neighboring hairy particles, also indicated as 100 and sometimes referred to as “nodes”, tethered to the center node through the “hairs” 115 comprised of multi-walled carbon nanotubes (MWNTs). The coordination number (or the number of tethered nearest neighbors, six in this example) is an important parameter and can be varied from 4 to 20 but 4 to 8 is better suited for this application. In an embodiment, the hairy particles (a total of seven shown in FIG. 1) are comprised of, for example, a high density microporous carbon aerogel (CA) and MWNTs nanocomposite that together serves to add strength to the external MWNT matrix, provides a high density of surface accessible micropores and provides the high surface area to volume ratio required for high charge density within the fractal microstructure. Although an aerogel will be described for this and other embodiments of the present invention, a xerogel can also be used in each such embodiment, and can result in higher densities.

The hairy particles (50 nm to 10 um dia. and preferred 100 nm to 300 nm dia.) are formed in-situ during phase segregation sol-gel processing during which a MWNT aerogel is formed as an external matrix for an internal carbon aerogel phase that serve as interlocking or encapsulating nodes within the MWNT matrix. The spacing of the hairy particle nodes allows for mass transport channels 110 between the nodes. Typically the cross-sectional area of the channels between nodes is 100 nm² to 1 μm² and, for some embodiments, preferably between 100 nm² and 0.1 μm². The CA nodes are tethered together by at least four (4) MWNT's 115 and up to 20 MWNT's or more per node. Strength is gained through increased coordination number of the CA nodes or by strength building additives that may be added prior to or during the sol-gel processing of the external MWNT phase to coat the MWNTs for enhanced mechanical properties. Such additives can comprise graphene oxide or a suitable polymeric additive or a polymer forming monomer with an initiator. After treatment, the coating may be carbonized. In some embodiments, prior to adding a non-conductive additive, the MWNT matrix is tested to demonstrate adequate conductivity through percolation. The simplification of ink design is achieved through upfront materials design rather than within the device manufactures ink deign effort.

The fractal, sometimes herein referred to as a hairy electrode fractal (HEF) shown in FIGS. 1 and 2A-F is an engineered volume element typically built into a micron-scale particle (HEF particle) FIG. 2B or a centimeter scale bulk HEF material (not shown), and it represents the smallest electrode feasible for achieving the five functional electrode requirements. In the bulk HEF material (not shown), these HEFs are typically mechanically interlocked by shared MWNTs 115 to all adjacent fractals during the phase segregation sol-gel forming process as described in greater detail hereinafter. A design objective is to assure adequate tethering without breaks between the CA nodes of each microstructure. Such fusing can be also accomplished by chemical means during the sol-gel process. In an embodiment of the invention, the fractals preferably represent a continuous pattern within a bulk HEF material formed by phase segregation sol-gel processes.

Although it is feasible to print form the sol state and then dry into a monolith directly, it is more common to gel and dry the HEF bulk materials and then mill them directly into micron scale HEF particles FIG. 2B that are each comprised of one or a plurality of fractals, FIG. 1 and FIG. 2A. Next, those milled HEF particles are formulated into printable inks and print formed and fused into addressable energy storing cells. The HEF particles shown in FIG. 2B can be carbonized and activated after the milling or before the milling using techniques known to those skilled in the art of in sol-gel processing for electrode materials.

The invention reduces significantly or eliminates the failures of prior art by designing directly into each micro scale HEF particle the five nanoscale functional requirements of a fully functional electrode. As such, various alternative types of designer particles can be used to interlock in a manner that a monolith composite is formed in-situ with a resolution approaching that of the dimensions of the HEF particles. The resulting composite can be formed, for example, by way of 3D printing, which enables a unique array of features that are not found in prior art. These features include isolated energy cells for enhanced safety, addressable energy cells for complex functionality, and ultra-thin and highly flexible energy storing devices. The resolution of the 3D printing process can vary over a wide range, from approximately the particle dimension to many times that, although in an embodiment the range is approximately four times the particle dimension.

In an embodiment, the electrode of the present invention comprises a plurality of HEF particles interlocked at a micron to centimeter scale or more, such that the combination can be regarded as an electrode monolith. The hierarchical progression graphically illustrated in FIG. 2A-F from the fractal, 2A to a fused monolith, 2C by way of an HEF particle, 2B radically alters the electrode design process when fully realized. Each HEF particle is comprised of one or more hairy electrode fractals (HEF) that each lock-in the five functional requirements of an electrode. Each such HEF, in accordance with the invention, is a fully functioning electrode on a sub-micron scale thus forming a protected “core” 205 within each particle that does not require any binder or pore forming agents found in the binder-based carbon particle electrodes inks that are typical of the prior art.

Another objective in at least some embodiments of the invention is to enable densification of the printed particles having a protected core 205 through fusing of the porous shell layer 200 of each HEF particle. In the present context, a “shell” is a mass of hairy nanofibers 105 surrounding the core of the each particle, rather than a solid structure as a shell is sometimes thought of. The hairy nanofibers of one particle are “fused” to those of the adjacent particles by any suitable means, as discussed below and illustrated in FIG. 2C. The fusing of the nearest neighboring porous shells 220 provides the desired strength, flexibility, conductivity and inter-particle mass transport properties, indicated at 110 in FIG. 2A. In an embodiment, shell development is enhanced by modifying the nano-fibrous surfaces of the HEF particles in a manner to form a porous “shell” of fusible conductive or non-conductive materials such as nanometals, nanoscale metal oxides or photo-initiators for vapor phase polymerization and is illustrated as a thin outer band 200 in FIG. 2B. One aspect of this embodiment of the invention relating to the enhanced shell development is to first form a nanocomposite, leveraging the surface-accessible MWNT's 120 of the HEF particles FIG. 2B with the shell forming agent, so that the resulting nanocomposite is porous.

The HEF particles, with or without enhanced shells 200, are next formulated into inks, printed, dried and then fused 220 into an electrode monolith as graphically illustrated in FIG. 2C. In at least some embodiments, treated HEF particles comprise shells enhanced to enable fusing, by any suitable means known in the art, of all adjacent HEF particle shells without any detrimental impact on the internal core of the HEF particle.

In the case of unenhanced shells, the dry and calendared (dynamically pressed) HEF particles can be interlocked by entanglement of the surface MWNTs within the shell 200 of FIG. 2B, and further detailed in images of FIGS. 2D-2F using a previously demonstrated pulsed irradiation technique and illustrated in FIG. 3.

The HEF particle version of the present invention can be thought of as a “designer particle” or a micron-scale hierarchical composite of multifunctional sub-micron hairy particles 100 tethered by MWNT 115 to form a network inclusive of transport channels 110 in a manner that the materials of the particle and their processing during manufacturing are designed to provide all five functional requirements of an electrode within at least some particles in certain embodiments, and within each and every particle in other embodiments.

To achieve a distribution of the isolated carbon aerogel (CA) nodes having accessible microporous surfaces and a high surface area within a MWNT matrix a number of embodiments specified below are provided:

In an embodiment, shown in FIG. 4, a MWNT aerogel is first formed, as shown at 400 and 405, and dried by known means, 410. Enhanced properties are feasible with pulsed magnetic field manipulation while in the sol state, step 400, but prior to crosslinking, step 405. Once gelled and dried, step 410, the aerogel can be consolidated to enhance the density using, for example, micro-spark plasma sintering, sometimes referred to as a high current pulse method, which involves applying short current pulses to the bulk material. Alternatively, if thin films are being used, enhanced density can be achieved with pulsed irradiation of suitable wavelengths and intensity in a manner illustrated in FIG. 3. A pulsed irradiation source from Xenon Inc. is an example. Once the MWNT matrix is ready, the hairy particle nodes 100 are formed by use of known RF sol-gel emulsion technology. The sol-gel is formed within the internal phase of a microemulsion of suitable size suspended in, for example, cyclohexane 415. The properties of the sol droplets are such that they wet the MWNT matrix illustrated in FIG. 2C during blending under shear with concurrent evaporation of the organic phase. Enhanced inclusion may be achieved by first modifying the outer MWNT wall with an initiator for the RF polymerization. The gel is then formed in a manner that includes the MWNTs it comes into contact with, thus forming the hairy particles 100 in-situ as illustrated in FIGS. 1 and 2A. A variation of the process includes the incorporation of graphene oxide within the sol mixture, shown at 415, which can then be annealed to the MWNT matrix to assist in forming the gel over intersections of MWNTs of the matrix rather than within the pores between the MWNTs. Alternatively, the micro-spark plasma sintering technique can be used to heat the intersections and thereby attract the emulsion droplets to MWNT intersections, shown at blending step 420. This annealing step is followed by gelling through polymerization of the RF droplets, step 425 and drying, step 430, using known techniques to form a xerogel or aerogel. Next, a carbonization process, shown at 435, is applied to the aerogel to yield highly conductive bulk material, or an electrode monolith. That monolith is then milled to yield the HEF particles, FIG. 2B. FIG. 4 illustrates an embodiment of a process that captures the overall intent of the microstructures represented above.

Variation to Preferred Embodiment.

A variation on the embodiment shown in FIG. 4 incorporates, as an additional step 400, an assisted self-assembly coating step. In this variation, the MWNTs within the formed aerogel or xerogel are coated by subjecting the as-formed aerogel or xerogel to, for example, a graphene oxide suspension, or a film-forming polymer suspension, or monomeric vapor phase cationic polymerization. Following the coating process, the modified matrix is dried and may be carbonized before impregnating with an RF emulsion.

As an alternative to the graphene-related embodiment shown above, but also illustrated by the process of FIG. 4, a dried MWNT aerogel can be created using super-critical CO₂ (scCO₂), slow isotropic freezing, or ambient drying approaches. Hydrophilic polymers can be used for side-wall polymerization to create mechanically stable MWNT aerogel having suitable mass transport properties. The hydrophilic polymers can be chosen, for example, from the group of conjugated block co-polymers, specifically acrylic polymers, e.g. poly 3-(Trimethoxysilyl)propyl methacrylate in ethyl acetate (EA), methanol (MeOH) or any other polar solvent providing sufficient solubility of hydrophilic polymer in MWNT sol. After drying and carbonization, resorcinol-formaldehyde in the form of a stable fine emulsion in non-polar solvent with a droplet size of, for example, 10 to 100 nm is impregnated inside the pores of the MWNT aerogel matrix. A preferred RF droplet size range is presently believed to be 10 to 20 nm. Next, the RF droplets are made to include at least one and preferably a plurality of MWNT intersections throughout the matrix by an assisted self-assembly technique in order to form suitable nodes having a size between 0.05 to 1 μm. A preferred range is presently believed to be 0.1 to 0.3 μm. One example of assisted assembly is the use of an initiator to the RF polymerization through functionalization onto MWNT intersections. Preferably and after inclusion of MWNT unions and intersections, the RF droplets are made to gel through condensation polymerization. Subsequent supercritical drying, and carbonization results in a MWNT-CA composite monolith (not shown) having CA nodes 100 in the range of 0.1 to 1 μm, each having surface accessible micropore diameters generally in the range of 1-3 nm together with high surface area, and that are distributed throughout the MWNT matrix. The mass transport channels 110 between the CA nodes 100 are formed between the MWNT tethers 115 extending from the CA nodes 100 as illustrated in FIG. 1.

The defined size and density of the CA spherical particles that form nodes 100 is preferably, although not necessarily for all embodiments, adjusted to assure high surface area without loss of desired mass transport properties within the inter-CA nodes tethered by the MWNT aerogel support matrix. Similarly, the porosity of the RF carbon aerogel nodes within the MWNT aerogel will be tuned depending on R:F ratio, catalyst composition/concentration, water amount in monomer solution and drying process. This creates meso-porosity (20-30 nm), or micro-porosity (1-3 nm), or both.

Besides resorcinol-formaldehyde aerogel, many other known aerogels derived from organic-polymeric network can be used, among them methyl resorcinol-formaldehyde, polyimide, etc.

In another embodiment, shown in FIG. 5, the physical properties of the fractal are locked into the design by way of formulating a two-phase dispersion such as a microemulsion (sub-50 nm), fine emulsion (>50 nm to 300 nm) or seed site for polymerization of the internal phase to a MWNT matrix of suitable pore size and distribution function. This is accomplished by designing into the starting two-phase sol-gel the appropriate ratios of the carbon aerogel-forming phase within the MWNT forming aerogel matrix from which the properties of the particle or fractal “core” 205 are formed.

As an example, a sol of MWNT is formed in cyclohexane, at step 500, after modifying the outer wall of the MWNT to improve dispersion properties. Next, a preformed RF emulsion of suitable size is formed, at step 505, within cyclohexane as known in the art. Next the RF emulsion is added to the preformed MWNT dispersion in proportions suited for the desired inter-node pore distributions and then blended, shown at 510, in order to obtain a two phase sol system comprised of emulsion droplets of suitable size, shown at 520. In an embodiment, the inclusion of a controlled number of MWNTs within each RF droplet is accomplished under shear during controlled evaporation of the organic phase and blending of the two starting sols. This step may be enhanced by modifying the MWNTs using an initiator for the RF polymerization, as at 530. The use of a pulsed micro-spark plasma sintering technique through the generation of a thermal gradient near MWNT intersections enhances formation of nodes. Next, the two sols are allowed to gel by their respective mechanisms. The pre-cursor to the HEF bulk material is the gelled material comprised of an internal high density RF gel that includes at least one MWNT intersections within an external low density MWNT gel. The complex gelled bulk material, once dried and carbonized, shown at 540 and 550, forms at least one and preferably a plurality of the nodes 100 illustrated in FIGS. 1 and 2A.

As an alternative to the process discussed above, but also consistent with FIG. 5, a stable MWNT suspension applying non-covalent side-wall modification of MWNTs is prepared in an organic solution that is immiscible in water, using surfactants and/or copolymers resulting in soft MWNT functionalization by π-π staking. Next, an aqueous solution of resorcinol-formaldehyde monomer solution is introduced into the MWNT stable suspension, forming a stable emulsion. The stabilized emulsion of RF monomer in MWNT suspension results in an RF polymer/MWNT composite, specifically at least one node and preferably a plurality of nodes to a fractal microstructure providing tunable ranges of volumetric energy and power density. To facilitate the inclusion of MWNTs by the RF droplets, some MWNTs are pre-functionalized with an initiator for the RF polymerization. The size of RF droplets will be adjusted by:

Apparent viscosity of the RF sol in the range of 0.5-1000 mPas, preferably;

Rotation speed 100-5000 rpm, preferably 1000 rpm;

Ultrasonic agitation/rotation time from 2 hrs to 5 days, preferably less than 24 hrs.

Several variations of the foregoing process can also be used, depending upon the particular embodiment. Some of these are:

Variation 1: Formation of an immiscible colloidal solution in which the organic phase with dispersed MWNTs, described above, is mixed with a liquid aqueous phase monomer solution containing resorcinol-formaldehyde.

Variation 2: Formation of the uniform and stable dispersion of MWNTs in an organic solvent in equilibrium with aqueous resorcinol-formaldehyde phase using surfactants-amphiphilic molecules, preferably nonionic surfactants for non-covalent surface treatment that adsorb on the MWNTs surface and at the interface between MWNT organic phase and resorcinol-formaldehyde aqueous phase without impeding the polymerization of resorcinol and formaldehyde. A surfactant or a combination of surfactants can be chosen among, but is not limited to, graphene oxide, polyethylene glycol family, diethanolamides, glucosides, high MW alcohols, those based on ethylene oxide and alkylphenols, monoglycerides, and others, such as containing a carbon double bond, e.g. Tween 20, Tween 60, Tween 80 or others, such as Triton X-100, and sodium dodecyl sulfate (SDS).

Variation 3: variation 2, in which, resorcinol-formaldehyde polymerization takes place within colloidal aqueous particles in equilibrium with organic phase of dispersed MWNTs forming a resorcinol-formaldehyde polymer phase.

Variation 4: The colloidal solution of MWNTs dispersed in organic phase containing polymerized resorcinol-formaldehyde microspheres followed by freeze-drying or supercritical drying of the said colloidal solution.

Variation 5: Organic phase with dispersed MWNTs in equilibrium with immiscible resorcinol-formaldehyde aqueous phase formed from low polarity solvents from the group of hexanes, toluene, dichloromethane, diethyl ethers, hydrocarbons, petroleum ethers or a mixture of thereof.

In a further alternative process, but still consistent with the process shown in FIG. 5, a MWNT colloidal organic aerogel precursor is in equilibrium with aqueous resorcinol-formaldehyde phase is formed by using hydrophobic monomer or polymer solutions for chemical MWNT side wall functionalization, such as those chosen from cross-linked or non-cross-linked acrylonitrile-containing copolymers, substituted and non-substituted polystyrene family, esters, vinyl ethers and ketones, vinylpyridine and vinypyrrolidone family, and others.

It will be appreciated from the teachings above, and illustrated in FIGS. 1 and 2A-F, that the tethering by MWNTs of sub-micron hairy particles, comprising activated carbon nodes and sometimes referred to herein as carbon aerogel (CA) nodes, provides, a nanoscale entity having the desired mechanical and electrical interconnectivity to function as an electrode.

It will be appreciated further that, in some embodiments, by increasing the diameter of the MWNT, or by increasing the number of MWNT's per node, strength is increased but mass transport is negatively impacted, and thus a balancing is desirable depending on the particular design requirements for each implementation. Next, the microstructure's mechanical properties can be enhanced further through; 1) an increased coordination number of each node, 2) coating the MWNT tethers with graphene or polymeric additives, and 3) improving the mechanical properties of the hairy particle or carbon aerogel nodes through increased density among other means. Coating the MWNTs, without impacting the electrical properties, is accomplished by first entangling the hairs between HEF particles using pulsed irradiation or by a pulsed magnetic field if the HEF particles are magnetic prior to any coating treatment so as to preserve percolation properties of the underlying microstructures or fractals. When milled, the HEF particles are a result of rupturing some of the macro MWNT network during the milling activity.

A desired objective of each embodiment is a bimodal monolith or pellet on a centimeter scale that can be subsequently milled into micron scale HEF particles for formulating into inks while preserving all five functional elements on a sub-micron scale as a core 205 within each HEF particle FIG. 2B. A further objective is to enable continued hierarchal building of macrocomposites through the use of a shell-core design of the HEF particles that enables an inter-particle fusion process (shell-shell) 220 and assures correct trade-off between mass transport and strength of the electrode monolith all the while preserving the electrode's performance at the core 205 level within each HEF particle's microstructure. Modification of the HEF particle size impacts the trade-off between shell and core properties which in turn alters the macro properties of the device such as flexibility, durability and packaging efficiency. It is anticipated that a blend of HEF particle sizes will impact these features in anticipated ways through altering the packing efficiency of the electrode films.

In an embodiment, an objective of the invention is to design and build, through printing or other suitable techniques such as additive manufacturing, robust electrode monoliths from the nanoscale to millimeter or centimeter scale in a hierarchical manner while preserving the nanoscale functionality as shown by FIG. 2C. A previously mentioned shell-core construct is used to preserve the hierarchical composite build. An objective of the overall design is to reach greater than 50% of the HEF bulk monolith density from milled and fused HEF particles. To do so, the HEF particles may have their surfaces modified on a nano- to micron-scale to form a porous shell nanocomposite having a finite thickness inclusive of the hairy extremities 105 to the HEF particles and as described above to aid in forming a dispersion or to provide a fusible shell 200 on each particle. A shell 200 incorporates a band having an inner boundary defined as the encompassing tangent incorporating all hairy particles (CA material) and an outer boundary equal to the outer MWNT material to the hairy particles plus the enhancing agent if used. An enhanced shell 600 can thus be formed by coating or seeding the outer MWNTs to the HEF particle with nanometals, thermo-initiator, photo-initiator, plasticizing oligomer, nanometal oxide or other suitable materials as illustrated in FIG. 6.

The deposition of suitable shell forming agents 600 onto the HEF particles is accomplished, as just some examples, by dusting, sputtering, coalescing from a liquid or vapor condensation. Further, an enhanced shell that incorporates plasticize-able materials within the shell can improve the interaction between nearest neighbors through the selection of a vehicle containing a plasticizer. This permits a plasticized shell to be developed for subsequent thermal fusing of the HEF particles. Although, in some embodiments, the application for this invention will have a porous shell, it is understood that higher strength can be obtained with non-porous shells or blends of porous and non-porous shelled materials for developing novel hierarchical structural materials.

To form fusible shells 600, the HEF particles can be dusted with nanometal material as within a sealed chamber prior to formulating the coated HEF particles into an ink or an ink can be formulated with nanometals directly prior to printing or the HEF particles can be applied in a separate print step whereby a nanometal containing ink is then printed over the HEF particles previously deposited and then dried 600 and fused 610. An SEM of the fused shell material is depicted in FIG. 7. Alternatively, cationic, UV or thermally curable monomers can be used to penetrate a previously printed porous electrode or added in combination with the HEF particles and then printed prior to polymerization to form permanent seals or caps or interlocks as the result of interlocking with the electrode HEF particles.

In an embodiment, an enhanced shell is first formed by spray deposition of a nanometal ink (such as available from Nanomas Inc.) onto the HEF particles. Next, the nanometal dispersion is destabilized during the drying process prescribed by the manufacture (Nanomas Inc.) to form loose aggregates 600 on the HEF particles as shown by FIG. 6. Powder coating techniques can be used to create a printed film of the treated HEF particles. Alternatively, a dispersion of the treated HEF particles is possible using a non-solvent vehicle which does not remove the aggregates previously formed on the hairs of the shell 600. Once formulated into a printable ink, the treated HEF particles 600 can be deposited by spray or screen techniques and dried in a manner that does not convert the aggregates to metallic clusters 605. In some embodiments, calendaring and other coalescing techniques can be used to improve the density of the printed films. Once established, the aggregates 600 are converted to metallic clusters 605 using pulsed irradiation or the manufacture's multi-staged heating algorithm within a hot calendaring stage. Adjacent HEF particles are thereby fused 610 into an electrode monolith. FIG. 7 is an SEM microphoto of the typical metallic nodes 605 or 610 formed on MWNT using a similar technique to the teachings above.

Having fully described embodiments of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A hierarchical microstructure, or fractal, comprising carbon aerogel nodes distributed uniformly within a multi-walled nanotube aerogel matrix so as to include a plurality of MWNTs within the nodes and to form mass transport channels among the nodes.

2. A particle comprised of at least one fractal microstructure having hairs comprising a plurality of multi-walled carbon nanotubes (MWNTs) with at least an outer surface, and a shell material on the outer surfaces of the MWNT hairs wherein the shell is comprised of at least one of a group comprising nanometals, thermoinitiator, photoinitiator, polymerizable monomers, MWNT, and graphene oxide-coated MWNTs.

3. An ordered array of fractal microstructures, each having electrode performance characteristics, made continuous into a monolith by printing as a porous film, drying and carbonizing into an electrode.
